(19) United States
(12) Patent Application Publication
(10) Pub. No.: US 2005/0049953 A1
(43) Pub. Date: Mar. 3, 2005

(54) Real estate business method and system integrating multi-level network marketing, franchise management and web tools

(76) Inventor: Tuan Anh Vu, Las Vegas, NV (US)

Correspondence Address: WEISS & MOY PC, 4204 NORTH BROWN AVENUE, SCOTTSDALE, AZ, 85251, US

(21) Appl. No.: 10/929,022

(22) Filed: Aug. 30, 2004

Related U.S. Application Data
(60) Provisional application No. 60/499,808, filed on Sep. 3, 2003.

(51) Int. Cl. G06F 17/60

(52) U.S. Cl. 705/36

(57) ABSTRACT

A real estate business method and system integrating multi-level network marketing, franchise management and web tools provides an opportunity for members of the general public to receive training in and assist in negotiating and transacting contracts for the sale of real estate. A website provides a multi-level interface over which sales of and investment in real estate are managed. The business method and system include a business affiliation of various organizations including a website organization for hosting the website, a seminar organization for providing training in real estate transactions, a franchise management organization for providing storefront franchises to graduates of the seminars, and various service organizations to assist in operating the real estate affiliation, including an investment property management organization. The seminars provide training in the methods of the business affiliation, in particular the location and purchase of properties with equity in excess of the purchase price or with positive cash flow. Certified graduates are offered franchises for storefronts and/or seminar training programs and can access higher levels of the website, which provides special tools for the graduates' use.

### CROSS-REFERENCE TO RELATED APPLICATION

This application is related to U.S. provisional application Ser. No. 60/499,808 filed Sep. 3, 2003 and from which it claims benefits under 35 U.S.C. §119(e).

### BACKGROUND OF THE INVENTION

1. Field of the Invention

The present invention relates generally to real estate business methods, and more specifically to a business method and structure and Internet methods and website for operating a real estate web transaction, education and franchising operation.

2. Background of the Invention

Real estate transactions as to the public, have generally been accessible only as purchases and sales arranged through the viewing and contracting for properties, typically a primary residence through real estate brokers and agents. While Internet auctions of properties have been made on Internet auction sites, Internet sales and auction sites generally do not provide the support and focus required for a user to properly engage in and complete a real estate transaction. Further, Internet sales and auction outlets provide no training in real estate business to the lay person as needed for enabling real estate transactions to become an Internet “e-business”.

Investment real estate transactions, in which multiple parties may purchase and jointly own properties and in which contracts for the sale of real estate may be traded or sold, have generally not been available to the general public at all. Investors in real estate, who may be educated as real estate agents or brokers, educated as attorneys or otherwise having expertise gained through experience, have the advantage in exploiting money-making opportunities through the sole or joint purchase of real estate for investment purposes. The general public can invest in typical long-term investments and until recently, with the advent of stock market day-trading, had little opportunity to take advantage of short-term gain opportunities. While day-trading of securities can be performed via the Internet, no provision is made for Internet support of short-term real estate transactions, as special requirements must be met and users of the system must have training in order to adequately perform many of the steps required to negotiate and transact short-term real estate investments.

Seminar organizations in the past have provided education in investment real estate transactions, particularly with respect to locating properties nearing foreclosure or otherwise available on the market at a price substantially lower than the available equity in the property or potential income from the property. Purchase of such properties provide a significant investment opportunity as well as potential benefit to a mortgagor, who may stand to lose the property and his or her investment or capital entirely unless a buyer is found. However, the education provided by the above-mentioned organizations is generally directed toward individual effort and standard techniques of finding a property, contracting for the purchase and reselling or keeping the property, and not toward building a support structure that can sustain a large-scale real estate operation providing opportunities in a variety of areas for individuals trained by the seminar organizations. Further, such seminars do not provide an organizational form for their graduates can use to further improve and build a business on what they have learned.

Multi-level network marketing (MLNM) organizations have been developed in the past for selling products and services to the public, and for providing an opportunity for members of the public to make money by selling the products and services, as well as by encouraging others to join the MLNM structure. Commissions on memberships and sales of members are generally collected by the MLNM organizations and paid out in a tiered mechanism that rewards members based on their sales and referrals. However, such organizations generally do not lend themselves to real estate transactions, as most principalities regulate the delivery of real estate commissions to only licensed individuals and within licensed organizations. For example, a typical real estate agency shares commissions in a hierarchical structure, but the commission receivers generally must be real estate agents or brokers. Further, the real estate commissions charged by such entities serve as a bar to effective operation of a real estate investment organization or a MLNM organization involved in real estate sales, as involvement of a broker or agent adds cost (typically 5-8%) at each transaction. Further, the restriction of rewards for sales and referrals to only real estate agents or brokers limits the ability of an MLNM or any organization to properly reward the efforts of a member of the public who does not wish to become a real estate agent or broker and who wants to put their efforts into real estate negotiation, real estate location and many other useful services that may be performed for others.

Therefore, it would be desirable to provide real estate business methods, a real estate business structure and an Internet website for negotiating real estate transactions that provide training, support services and a reward structure to members of the public who wish to become involved in the many facets of real estate sales and investment. It would further be desirable to provide an organizational structure for the graduates of the above-mentioned training, so that they may further improve their ability to earn money and build a business in real estate. It would further be desirable to provide an Internet website that facilitates investment in real estate.

SUMMARY OF THE INVENTION The above-stated objectives of providing real estate business methods and structures as well as an Internet website that facilitates investment in real estate, for training supporting and providing rewards to persons wishing to become involved in real estate investment or transactions are provided in the methods and systems described herein.

A business affiliation that includes: an Internet website corporation for providing a real estate transaction website, a seminar organization for training members of the public in negotiating and executing contracts for the sale of real estate and a franchise management organization for franchising storefronts to graduates of the training seminars. The affiliation also includes various service organizations for supporting the real estate affiliation and its franchisees, as well as a property management organization for managing investment in property.

The business affiliation provides seminars for training persons in the location and execution of contracts for the sale of properties having equity in excess of the purchase price or positive cash flow and certifies graduates of the seminars. Certified graduates are offered franchises such as virtual or actual storefront franchises and/or seminar franchises and franchises are established for the certified graduates if the certified graduates purchase the franchise and after an appropriate waiting period.

The website corporation provides a website that has a multi-level interface, where some levels of the interface are available only to certified graduates of the seminars who pay a membership fee. Various features are provided for listing of properties or other interests in real property for sales and purchase. The website also provides tools for operation of franchises and for property location and purchase, as well as advertising for seminars and franchises. The website also provides features for executing multi-purchaser contracts for the acquisition of investment properties, as well as communications and negotiation tools/interfaces for investors to locate and evaluate each other.

The website itself comprises a method, computer system and computer program product for providing the multi-level interface mentioned above.

The foregoing and other objectives, features, and advantages of the invention will be apparent from the following, more particular, description of the preferred embodiment of the invention, as illustrated in the accompanying drawings, wherein like reference numerals indicate like components throughout.

### BRIEF DESCRIPTION OF THE DRAWINGS

FIG. 1 is a block diagram depicting organization of a business model in accordance with an embodiment of the present invention.

FIG. 2 is a block diagram depicting detailed organization of a seminar portion of the business model of FIG. 1.

FIG. 3 is a block diagram depicting detailed organization of a transactional portion of the business model of FIG. 1.

FIG. 4 is a block diagram depicting organization of a property holding/management organization in accordance with an embodiment of the present invention.

FIG. 5 is a block diagram depicting relationships between an organizational model in accordance with an embodiment of the present invention and various internal and external support organizations.

FIG. 6 is a flowchart depicting a flow of property transactions in accordance with an embodiment of the present invention.

FIG. 7 is a flowchart depicting a flow of training promotion and franchise operations in accordance with an embodiment of the present invention.

FIG. 8 is block diagram depicting a computer system in which methods of the present invention may be practiced.

### ILLUSTRATIVE DESCRIPTION OF EMBODIMENT OF THE INVENTION

The present invention concerns a website and business structure for presenting seminars to the general public, initiating and executing real estate purchases and sales, training persons in the acquisition and disposition of real estate with equity or cash flow and establishing and maintaining franchise and joint venture relationships. The business structure operates in conjunction with the website, and the website provides various features for each of the components and members of the business structure.

The business structure illustrated herein is an affiliation of corporations and their franchisees and joint venture partners. The corporations may be separately held public entities that have contracts with each other that define the relationships and duties between the components of the business structure. Alternatively other suitable forms of business entities or a single entity may be used to implement some of the features of the business methods of the present invention that do not concern an actual structure of the business and are therefore contemplated as being within the scope of the present invention.

The illustrative business structure or “business affiliation” described herein includes a seminar corporation that markets seminars to the general public and franchises the business of presenting seminars to seminar franchisees or which presents seminars to the general public with co-sponsors. The business affiliation also includes a website corporation that owns and manages a website for marketing programs of and providing tools for implementing the goals of organizations within the business affiliation. The business affiliation further includes a “storefront” corporation that franchises individuals to establish actual or virtual “storefronts” for assisting in the location, purchasing and resale of properties with equity in excess of the purchase price or with positive cash flow. The business affiliation also includes a corporation that franchises real estate agents to assist in closing real estate transactions for a set fee. The business affiliation may also include a corporation that provides services in establishing business entities (corporations, LLCs, LLPs) and providing bookkeeping and tax services. The business affiliation may also include a mortgage corporation that lends to qualified members in the real estate transactions and title companies that close and/or insure title. The mortgage company and title companies are familiar with the particulars as to the business methods described herein, in order to facilitate the transactions.

The business affiliation also contains a multi-level network marketing (MLNM) corporation, where initial sales contacts to the business affiliation are recognized in the form of royalties awarded to the referring individual for earnings generated by the referred individual(s) as a percentage of fees paid by the referred individual to the various corporations within the business affiliation, to a level of five referrals deep. The MLNM is used primarily to market the franchises of actual or virtual “storefronts” which are franchisees that facilitate the location, purchasing and resale of properties with equity in excess of the purchase price or with positive cash flow, services of the services corporation and the services of the mortgage corporation. The MLNM is also used secondarily to market the website services of the business affiliation and the real estate agent franchises.

Real estate “sales” and “purchases” within the context of the present invention include sales of equity interests in properties. For example, a property owner may sell a fractional interest (or a buyer may buy a fractional interest) in a property in order to raise capital for investment or other purposes. “Sales” also include sales of contractual rights prior to closing, so that effective ownership of a property may be transferred multiple times prior to completion of an actual deed transfer (closing).

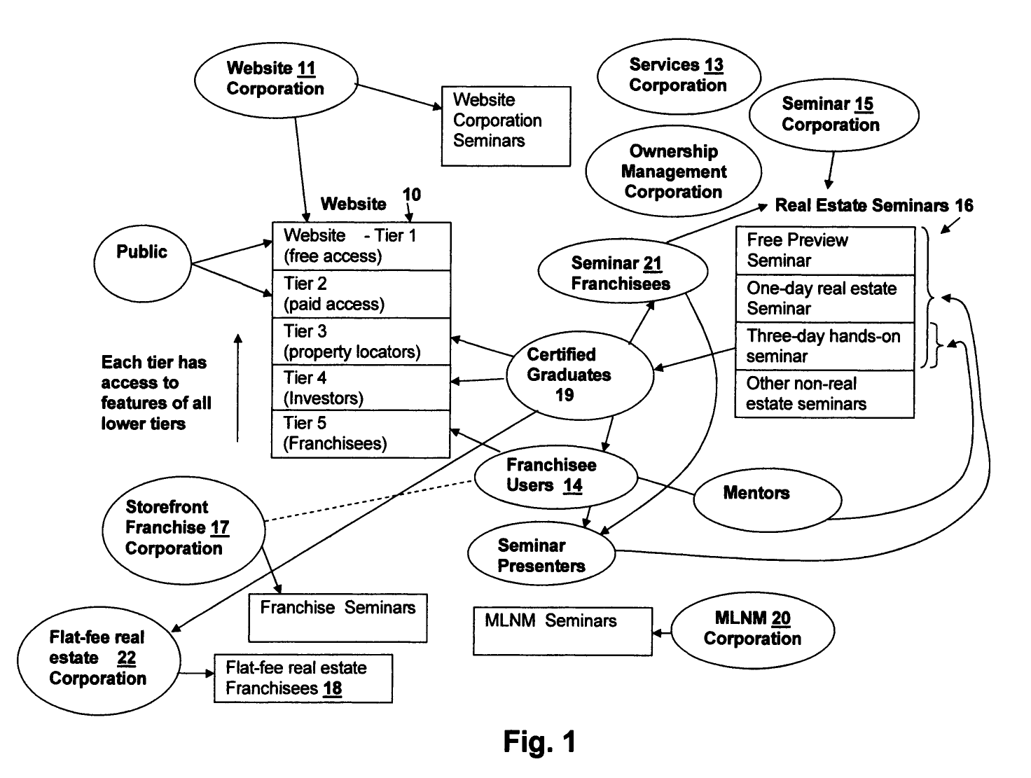

With reference now to the Figures, and with particular reference to FIG. 1, a business affiliation is depicted in which business methods in accordance with embodiments of the present invention are performed. A website 10, owned and maintained by the website corporation 11, is used to execute portions of the business methods described herein, as well as to provide a marketing tool for promoting the options offered by the business affiliation. The website 10 generally provides communication between website members, analyzing and improving the performance of members, postings of real estate offerings, notices of seminar offerings and tools for maintaining the relationships between members and the business affiliation. The tools include on-line and printable forms for executing contacts for the sale of real estate and systems for tracking the activities of members, as well as systems for tracking fees, payments and royalties to and from the various elements of the business affiliation.

The website 10 includes 5 tiers, the bottom two of which are available to the public. Each higher-level tier includes access to all features of the lower tiers and provides communication with users at the same tier (with the exception of property locator tier 3) and lower tiers, via techniques such as chat or site-bound e-mail transactions where the actual e-mail address of a user is generally hidden from access.

The lowest level, tier 1, is a free access site that permits registered users to upload information about properties for sale or view other properties for sale. Users may register for free and access is provided with a username/password combination. The site also supports property searches at this level, filtered by price, location, type and construction. Free users are not allowed to upload photographs or documents supporting the property offer. Users on tier 1 can communicate with users on tier 2 as well as users on tier 1, as tier 1 and tier 2 users are only offering or seeking properties for sale. A disclaimer is provided to website users that the reliability of information on website at tier 1 is totally disclaimed by the website corporation and users are advised that the identity and credibility of all users on tier 1 are not verified by the company. Tier 1 members may be barred from the website for repeatedly providing false information, but the disclaimer provides that the website company has no liability or responsibility for not barring a tier 1 member.

At the first tier, members are referred via the website 10 to a broker or real estate agent franchised by the business affiliation who can assist in closing, a title or escrow company which is part of the business affiliation, an attorney certified by the business affiliation that is familiar with the business methods and forms used by the business affiliation and its franchisees for closing their transactions.

At a second-tier, which is also available to the public, users are required to pay a monthly service fee for membership, which is paid monthly by credit card. On tier 2, the reliability of information on the website is generally disclaimed, but users are informed that the person providing the information has registered with the company and has provided a credit card to verify his or her identity. Also, if other users complain of blatant falsehood by a user, that user may be barred by the company, but the company otherwise has no liability or responsibility for not doing so. The verification of identity adds credibility to tier 2 users. Second-tier access permits a user to upload photographs of properties for sale, documents such as mortgages and contracts, and for buyers, letters of pre-qualification for financing a purchase. The pre-qualification letters provide credibility to the users on prospective purchases/offers. The upload capability provides added value to the sellers, as they can provide photos of their properties and/or supply such documents in support of their ownership of and liabilities on property (e.g., mortgages and deeds). At the second tier, offers can be made on properties through the use of on-line interactive forms that create a binding contractual arrangement between a buyer and seller that can be subsequently consummated via a traditional real estate transaction handled either by a broker or real estate agent 18 franchised by the business affiliation, by a title or escrow company which is part of the business affiliation, an attorney certified by the business affiliation that is familiar with the business methods and forms used by the business affiliation and its franchisees 14, or an outside real estate agent or broker, title company, escrow company or attorney.

The third and fourth tiers in the website are accessible only to certified graduates 19 of the training programs provided or sponsored by the seminar corporation, its co-sponsors and/or its franchisees. The third tier is available to all graduates of the training programs of the seminar corporation who pay a monthly fee for membership to the website by credit card. The information on the third tier is generally disclaimed by the company, but website users are informed that property locators and investors having access to tier 3 are graduates of the training programs of the seminar corporation, their identity is verified by credit card and training registration forms, and that tier 3 users are subject to being barred for repeatedly providing false information, but that the company has no liability or responsibility for not doing so.

The users of the third tier are known as “property locators”. Property locators generally use the website to locate and post information on properties for purchase by themselves, with others or for others and can communicate with users on the lower tiers in order to facilitate transactions. The trading history of a property locator is accessible to investor and franchisee users (tier 4 and 5 users). All of the above information provides additional value and credibility to property locators, as well as investor and franchisee users accessing tier 3 information. The form provided by the website corporation for the posting of the information on a property is specifically designed to provide all information investor or franchisee users need to quickly qualify a property as falling within their purchase criteria, including criteria taught within the seminars. The form provides greater value to both property locators and investor/franchisee users.

Property locators are instructed in the use of contract forms proprietary to the business affiliation via the training programs. Property locators cannot contact other property locators and cannot contact users at higher levels. Property locators cannot seek investors other than by posting contracts for purchase using the on-line proprietary forms that can then be searched by users at the higher levels. Property locators are the lowest level of user that can sell or assign their personal property rights, such as mortgages and contracts for the purchase of property that have not been consummated via forms specifically provided for that purpose.

The fourth tier is provided for investors who are certified graduates of the training programs and also pay a monthly fee by credit card. Information on tier 4 is generally disclaimed by the website corporation, but a user accessing information from tier 4 is informed that tier 4 users (investor users) are graduates of the training, have had their identities verified by credit card and training registration forms, and are subject to being barred for repeatedly providing false information, however, the company has no liability or responsibility for not barring an individual. Each investor user's trading history is accessible by other investors and franchisee users. The above information adds credibility to an investor and greater value to the website.

Investors can post information about their available capital and their investment criteria (e.g., type of property preferred, sole owner only, etc.). Investors can contact each other and view the others' investment information so that agreements can be reached for fractionalized purchase of a property. A lead investor initiates an attempt to aggregate capital for a combined purchase of property and joins other investors who must approve their percentage of ownership and monetary commitment to a purchase as further explained below.

The website corporation 11 further provides a tool that is an agreement for the governance of purchases, management, and sale of the property by multiple investors through the use of on-line interactive forms. Another corporation 13 within the business affiliation offers services of forming and maintaining business structures, tax filings, acting as registered agent, and keeping records for the groups of multiple investors, who learn of its services through the website, the seminars, and emails. The business affiliation thereby provides additional products and services that may be marketed by the “services” corporation 13 and all members, who, upon purchasing a corporate package, qualify to be representatives of the corporate services corporation 13 and can become members of a MLNM marketing group within the services corporation. The primary MLNM corporation 20 mentioned above also sells theses services for the corporate services corporation.

The fifth tier is the highest level in the website, and is available to user franchisees 14 of the storefront franchise corporation (the corporation that franchises actual or virtual storefronts). Franchisees 14 have access to all other levels, all other information and tools and all other users on the system, as well as to tools on tier 5 for facilitating the operation and organization of their franchises, presentation and promotion of seminars, and for communicating with other franchisees 14.

A second part of the relationship within the business affiliation depicted in FIG. 1 is a training program and business relationship structure outside of the website relationships.

The website corporation 11, the seminar corporation 15, and/or the storefront franchise corporation 17 co-produce an infomercial (television information commercial) that promotes not only the website 10, but also the seminar corporation's related seminars 16 and/or the virtual and actual storefront franchise corporation's franchises. The website corporation 11, either alone or together with the seminar corporation 15, its co-sponsors, and/or the virtual and actual storefront franchise corporation 17, conducts a free preview seminar that serves as an introduction and marketing tool for encouraging enrollment in the paid seminars.

The website corporation 11 conducts a one-day paid seminar, in which an attendee is taught the use of the website and basic concepts behind the real estate transactions on the website including: legal concepts, how to locate and acquire real estate with equity, and the use of forms specific to the business affiliation, and in which discounted further training and multiple term website services are encouraged to be purchased. At the one day website seminar, attendees are encouraged to enroll in a one day and/or three day real estate seminar developed by the seminar corporation within the business affiliation. The services corporation's 13 services and products are marketed, either directly or by reference to a separate seminar to be conducted by the corporate services corporation 13 and the storefront franchise corporation's 17 franchise system and its seminars are also marketed by referral to its free seminars.

The one-day real estate seminar teaches in greater detail the process of locating, acquiring, and selling real estate with equity, both by the more classical methods as well as by using the website and being a franchisee 14 of the storefront corporation 17. The teachers at this seminar may either be professional seminar teachers who may or may not have experience specific to the techniques of the business affiliation or more classical methods, or the teachers may be seminar graduates who may or may not be franchisee users 14.

The three-day hands-on training seminar conducted by the seminar corporation 15 gives attendees hands-on experience in the process of locating, acquiring, and selling real estate with equity, both by the techniques of the business affiliation, as well as the more classical methods. The teachers in this seminar are franchisee users and/or other successful graduates of seminars conducted by the seminar corporation 15, its co-sponsors and/or its franchisees. Providing instruction by franchisee users 14 or other successful graduates of the seminars 16 gives additional value to the attendees, as attendees will be taught by trainers having specific experience using both classical methods and the methods of the business affiliation, who are successful in the application of those methods.

Mentoring relationships between the attendees and franchisee users 14, successful seminar program graduates 19, co-sponsors or seminar franchisees 21, are established at the three-day seminar, which benefits the attendees by providing a mentor who is successful in using the business methods of the business affiliation who is accessible at all stages of the new seminar program graduate's efforts to locate, buy and resell property. The mentoring system benefits the franchisee users 21, successful seminar program graduates 19, co-sponsors and/or seminar franchisees 21 as a means of finding new people to work with who have had training specific to the methods of the business affiliation, as well as a means of finding prospects to sell a two-day seminar provided by the corporation related to operation of and methods of selling storefront franchises. The mentoring system further provides a system for marketing and selling storefront franchises, franchises to assist in real estate closings, the corporate services corporations' 13 services and recruiting representatives, for which the franchisee users 14, successful seminar program graduates, co-sponsors and seminar franchisees 21 receive compensation through the MLNM corporation 20.

Graduates of one or more of the paid seminars 16 are certified graduates 19 of the training program and may become investors, placing notices of available capital on the website, or franchisee users 14. Franchisee users 14 may assist the seminar corporation 15, its co-sponsors, its franchisees 21 and/or the storefront franchise corporation 17 in providing training and mentoring that would otherwise have to be provided directly by one of the business affiliation corporations. However, seminar franchisees 21 and storefront franchisees 14 are franchised separately by the seminar corporation 15 and the storefront franchise corporation 17 and therefore graduates 19 may become one or both, depending on which franchises they buy and availability of seminar franchises, which are geographically limited. Graduates of the seminars may also become property locators, as knowledge of the use of the proprietary contract forms is required before a person can become a property locator (i.e., a property locator must be a certified graduate of the training program).

The above-described seminars 16 may be presented and promoted by the entities listed above (website corporation 11 for the website seminar, corporate services corporation 13 for the services seminar, etc.), may be provided by seminar franchisees 21 of the seminar corporation 15 or be provided by a joint venture arrangement (referred to herein as co-sponsoring). All seminars are marketed by the MLNM corporation 20. Seminar franchisees 21, co-sponsors, and the MLNM corporation 20 thus provide the seminar corporation 15, services corporation 13 and storefront franchise corporation 17 with additional marketing leverage in areas where the seminar corporation 15, corporate services corporation 13, and/or the storefront franchise corporation 17 might not otherwise host or promote seminars or sell franchises or services.

The seminar corporation 15 sells franchises or enters into co-sponsorship joint ventures to provide seminars 16 and restricts seminar franchisees 21 on a geographical basis. The geographical restriction may be overridden by the seminar corporation 15 or its co-sponsor paying an encroachment fee to the franchisee 21, after the franchisee 21 fails to exercise a right of first refusal to conduct the seminar, which is one of the unique aspects of this business model. Seminar corporation franchisees 21 have the option to fulfill all aspects of advertising and conducting the seminars 16 that the seminar corporation 15 desires to hold in their geographic area, in which event the franchisee 21 pays a license fee equal to a percentage of the gross revenue to the seminar corporation 15, or to pass and receives an encroachment fee from either the seminar corporation 15 or its co-sponsor. A seminar corporation franchisee 21 may be permitted to participate as one of several co-sponsors of the seminar corporation's seminars 16, however, in that case it will not receive the encroachment fee.

The use of co-sponsors and the encroachment fee arrangements are unique features of the business methods of the present invention. The use of user franchisees 14 as trainers and continuing mentor relationships are also unique features of the business methods of the present invention. The use of user franchisees 14 as trainers cuts costs of training and hiring personnel to conduct the seminars 16, and avoids the typical use of professional trainers who may not have actual experience and intimate knowledge of how to locate, purchase, sell, and arrange fractional participations in real estate transactions using the methods taught by the seminar corporation 15.

A franchisee user 14 (storefront owner) may also participate as a co-sponsor of a seminar corporation seminar 16. The seminar corporation 15 and/or its other co-sponsors may also conduct these seminars 16, in the event the seminar corporation franchisee 21 opts to accept the encroachment fee. Seminar corporation franchisees 21 may also pay a licensing fee to use the infomercial produced by the website/seminar/storefront franchise corporations to promote additional seminars in their geographical area or may promote additional seminars by other methods of advertising. The storefront franchise corporation 17 and/or its franchisee users 14 can also pay a licensing fee to use the infomercial produced by the website/seminar/storefront franchise corporations to promote seminars to sell their franchises. The MLNM corporation 20 can also use the infomercial in its marketing program. Seminar corporation co-sponsors may also pay a licensing fee to use the infomercial produced by the website/seminar/storefront franchise corporations to promote seminars. The training program portion of the business as well as the business affiliation as a whole has an agreement with the franchisee users 14 to encourage them to teach the seminars 16 in the training program.

Another franchising component of the business affiliation is the “flat-fee real estate corporation” 22, as mentioned above. Franchisees are recruited by the flat-fee real estate corporation 22 at the various seminars mentioned above as hosted by the other affiliated corporations, by the entities giving those seminars, by the teachers at those seminars, by other flat fee real estate agents, or by members of the MLNM corporation, each of whom get a commission on the sale of the franchise, but not on the royalties on providing services as states require licensing to share those fees. After signing a contract on the website or at a storefront, it is not mandatory that the parties use the flat fee real estate franchisee 18. It is only suggested that they use that service, via a pop-up advertising that appears on the website 10 and sent emails or by referral at a storefront. The website 10 also sells advertising to attorneys, mortgage companies, and title companies that are familiar with the business techniques, preferably graduates 19 of the appropriate seminars or persons certified by the seminar corporation 15. The business affiliation as conceived may include a nationwide mortgage company, insurance company, escrow and/or a title company, the services of each of which will be marketed at the seminar corporation's related seminars 16, the storefront franchise corporation's seminars, the website corporation's seminars, on the website 10 and by the corporate services corporation's 13 representatives.

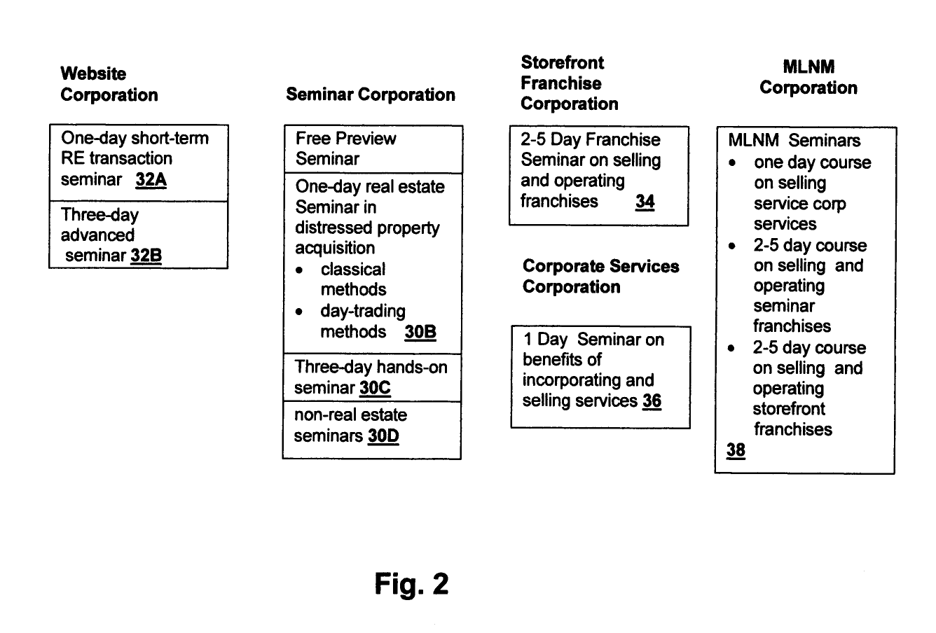

Referring now to FIG. 2, the training program of the business affiliation of FIG. 1 is depicted in further detail. The seminar corporation 15, by itself, or through its franchisees 21 and/or co-sponsors, gives a one day seminar 30B teaching the classical methods of distressed properties acquisition as well as how to use the methods with short-term real estate trading techniques as facilitated by the website 10 and/or through being a storefront franchisee 14. The teachers are professional speakers, graduates of prior seminars who have a record of actual success, and/or franchisee users. The seminar corporation 15 also gives a 3-day, hands-on seminar 30C, by itself, or through its franchisees and/or co-sponsors, but only graduates 19 of prior seminars 16 who have a record of actual success, and/or User Franchisees 14 serve as teachers. The seminar corporation 15 also gives seminars unrelated to real estate.

At the one-day seminar 30B, students are taught the basics of locating and qualifying suitable properties, approaching meeting an owner, qualifying the terms of a sale or other transaction, dealing with lenders and negotiating the purchase of/reselling the properties. In the three-day hands-on seminar 30C, students are familiarized with the process of locating and qualifying properties of finding and meeting an owner, negotiating and executing the contract and reselling the property through participating in the actual process guided by the teacher/mentor. Additionally, students are given hands-on training in executing the proprietary contract forms used by the website corporation 11 and the franchisees 14.

The website corporation 11 gives a one-day short-term real estate transaction seminar 32A and a 3-day Advanced Seminar 32B, using graduates of prior seminars who are successful real estate short-term traders and/or franchisee users 14.

The storefront franchise corporation 17 gives a two to five day training course 34 taught by franchisee users skilled in running its franchises and franchise attorneys, regarding the operation and selling of its franchises.

The corporate services corporation gives a one day course 36 on the benefits of incorporating and on selling the corporate services corporations services and products using successful representatives.

The MLNM corporation seminars 38 comprise a one day course on the benefits of incorporating and selling the corporate services corporation's services and products, using prior seminar graduates who are successful representatives. The MLNM corporation seminars 38 also include a two to five day training course on operating and selling the seminar corporation's franchises, taught by its franchisees 21 skilled in running the franchisees and franchise attorneys, regarding the operation and selling of the franchises. The MLNM corporation 20 also gives a two to five day training course on operating and selling the storefront franchise corporation's franchises, taught by franchisees users skilled in running those franchisees and franchise attorneys, regarding the operation and selling of the franchises.

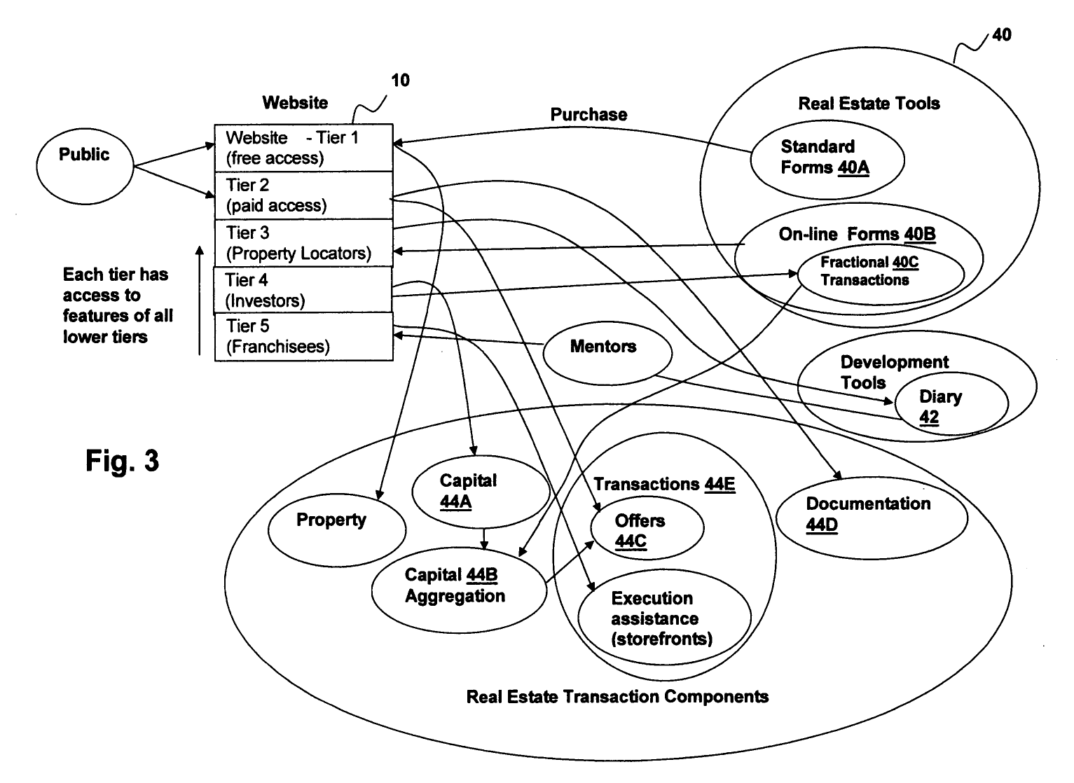

Referring now to FIG. 3, a transactional model of the business affiliation is shown. From the public portions of the website 10, standard forms 40A may be purchased for use as tools in completing a contract for a real estate transaction. The forms 40A are prepared by licensed attorneys for a particular state and are provided with a usage disclaimer. Property sales may be offered and accepted from the public access portions of the website, but only as offers between individuals that must be otherwise contracted outside of the system (unless an offer is made by one of the Tier3-5 members in which case the proprietary forms may be used). In any case, a valid real estate transaction closing must be executed after the sales contract as required by the locale.

Paid access public site members of tier 2 may provide documentation 44D as shown in the real estate transaction components, but only members of tier 3 and above may initiate execution of a transaction 44E (via a contract) using on-line forms 40B from the real estate tools. Tier 3 and above members also have a personal diary 42 (a “virtual diary”), generally used by their mentors to review and improve their performance. The mentor 46 also has access to the personal diary 42 of his mentored member.

After a contract has been executed, sellers and buyers are referred to a franchisee of the flat-fee real estate corporation 18 that is a licensed real estate agent in the area where the property is located. The real estate agent franchisee 18, for a flat fee, will “walk” the buyer and seller through the process of: putting the agreement on state-approved forms 40A (if not using the interactive forms 40B), getting a loan funded and performing title work required for closing. The referral of sellers and/or buyers to real estate agent franchisees 18 is a unique feature of the business methods of the present invention, as typically the assistance described above is only provided by real estate agents who have had an existing client relationship with the buyer and/or seller.

On tier 4, investors (and also user franchisees at tier 5 by inclusion on the lower level) may enter capital amounts 44A and investment preferences for prospective investment in real estate. The capital 44A may be aggregated 44B to show offers 44C on property that is to be fractionalized as described above. When a property is to be bought in fractionalized ownership, a lead investor finds other investors in the system and after every investor has approved the transaction (with respect to their dollar amount and percentage of the transaction) an offer 44C is communicated to the seller. Alternatively, the lead investor may contract the property as a “Buyer” including “assigns” to be determined after the price and terms of the purchase have been secured. The fractionalized transactions are then performed using proprietary forms 40C developed and owned by the business affiliation that ensure proper execution of a fractionalized transaction. Investor offer, purchase and resell histories are available at the website 10, so that a person participating in the transaction can qualify the lead investor or others participating in the fractionalized transaction.

Debit cards may be issued by a bank under a private label belonging to another corporation within the business affiliation: “the debit card corporation” to provide immediate access to capital as available to the investors. Debit cards may be backed up with any form of capital and may provide international access to capital funds for solo investment in property or used in the fractionalized transactions described above. The cards will be marketed by the debit card corporation, the seminar corporation 15, itself and through its co-sponsors and franchisees 21, the storefront franchise corporation 17, directly and through franchisee users 14, the corporate services corporation 13, directly and through its representatives, the website corporation 11 on its website 10, and the MLNM company 20. Each company and its sales person will receive a fee each time the card is used. The card provides yet another service for each corporation and its members and franchisees to sell.

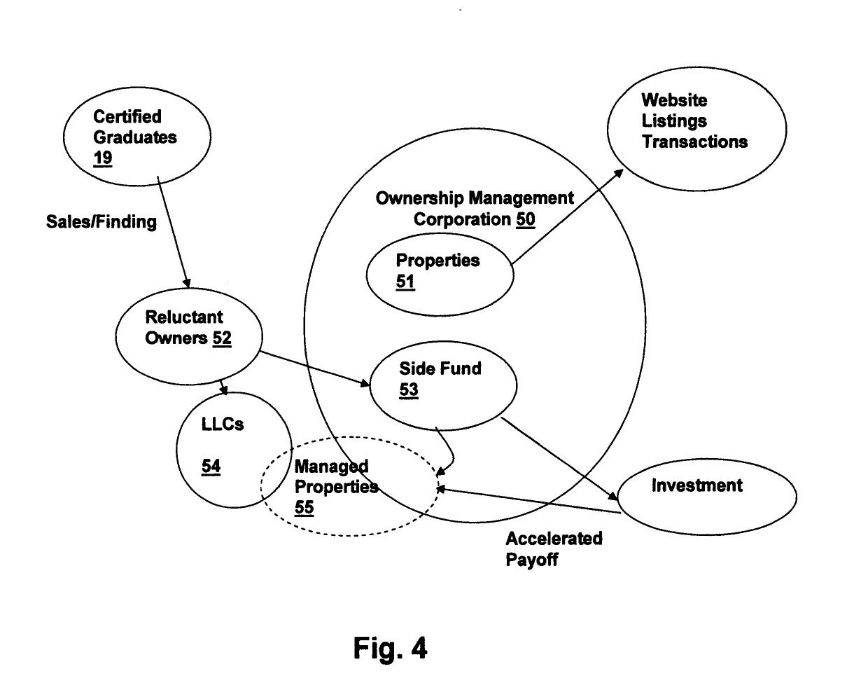

Referring now to FIG. 4, an extension of the business affiliation to property ownership is depicted. A management ownership corporation 50, which is one of the corporations within the business affiliation, is used to hold and/or manage property 51. The property 51 may be under contract or have been purchased by another one of the corporations in the business affiliation, an investor, or franchisee user 14. The management ownership corporation 50 may hold the property 51 for sale or cash-flow rentals and appreciation, keeping a volume of properties available for investment and purchase. Property locators may sell the properties to the management ownership corporation 50, or assign their contracts to purchase the properties prior to closing. The ability to assign adds value to the ability to sell or assign properties to the management ownership corporation 50 and adds value to the business system by providing another source of funds to property locators. Property locators or others may suggest properties for purchase by the management ownership corporation 50 and the property may be sold by the management ownership corporation to renters in the properties, through advertising in papers, or via the website, saving an agency fee. Investors and franchisee users may also sell properties to the management ownership corporation or assign their contracts to purchase properties prior to closing.

Property locators, investors and/or franchisee users may also offer to sell the properties to a person who is not an investor, but who has good credit and wants to buy a property for rental income, tax advantages, and/or appreciation, who also either lacks management skill or time to manage the property, and whose credit is sufficient to permit 100% financing. The above-described person is called a “reluctant owner” 52. The reluctant owner 52 would like to own several properties, if it were not for management demands and troubles and may be willing to pay a retail price for the property, if it can be financed 100%. Reluctant owners 52 are found through a free portion of the website appealing to them offering no down-payment properties as well as from surveys filled out by attendees at the free and paid seminars presented by the seminar corporation 15 and the website corporation 11. The property locator, investor, franchisee user 14 arrange for the reluctant owner 51 to finance the property for 100% and to close title, perhaps employing the services of the flat-fee real estate franchise corporation franchisee 18, the mortgage company, the escrow/title companies and/or the certified attorneys, generating more business for them. The availability of reluctant owners 51 adds value to the entire business model as a source of buyers who can provide funds to permit property locators, investors, and franchisee users 14 to cash out their equities in properties on an expedited basis, increasing their annualized rate of return on capital invested. Cashing out equities is the essence of the short-term real estate transaction techniques and is a major factor in making the business affiliation a success. Testimonials about high-profit in short time periods is a very strong motivational tool to induce attendance at free seminars, leading to higher paid attendance at later seminars and subscription to the website companies services, and sales of corporate services, and sales of virtual or actual storefront franchises.

Generally, the management ownership corporation 50 shares a 50% interest in the property 55 with the reluctant owner 52. The reluctant owner contributes to a side fund 53 which is invested by the holding company 54 and for which principle and earnings are used along with rental income to pay down the principle balance on the property at an accelerated pace, providing a system for maximizing capital yield on investment, while managing the acceleration process within the business affiliation. Generally, the reluctant owner forms an LLC holding company 54, hopefully using the corporate services corporation's 13 services, and deeds the property one-half to the to the LLC 54 and the other one-half to the management ownership corporation 50. The LLC 54 and management ownership corporation 50 enter an agreement providing that both the LLC 54 and the management ownership corporation 50 jointly manage the property 55. This allows the management ownership corporation 50 to use its expertise, while letting the reluctant owner 52 choose for himself whether to take an active hand in the daily management burden. The reluctant owner 52 might want to take an active part in management if he or she is unsatisfied with the management ownership corporation's 50 management, or the reluctant owner 52 may rely on the management ownership's 50 expertise in managing the property 55. When a property 55 becomes debt-free, the LLC 54 and the management ownership corporation 54 decide whether or not to hold the property for cash-flow or to sell the property and distribute the proceeds. The above-described methods of cashing out investors and providing reluctant investors with a management-free method of acquiring paid off properties, with no or a small cash investment, is unique to the invention.

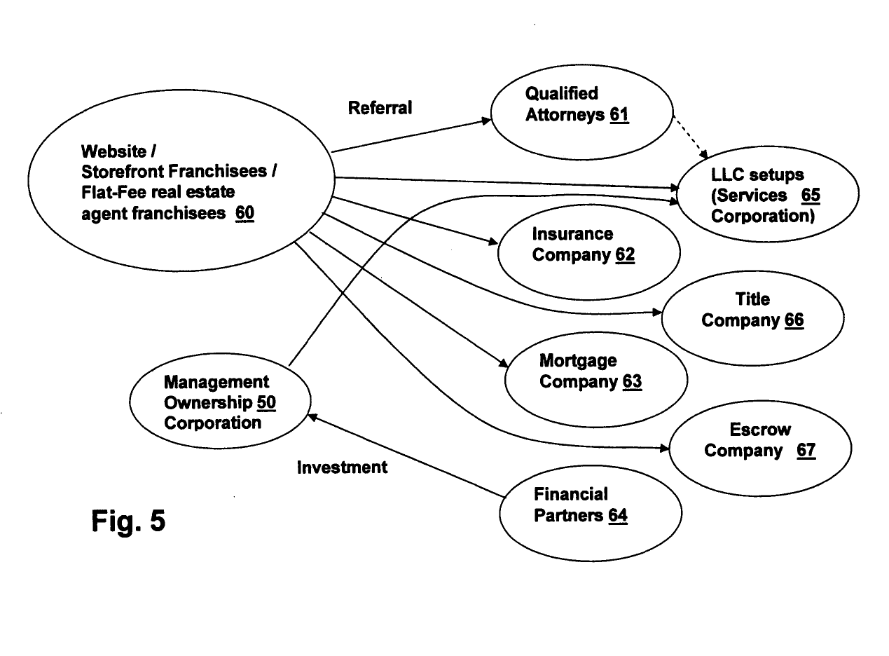

Referring now to FIG. 5, a relationship of the business affiliation 60 as described above to other entities that may be owned entities or outside entities, is depicted. Qualified attorneys 61 are used to generate the forms for the 50 states as sold on the website and are potentially used closings and other legal services. An insurance company 62, title company 66, escrow company 67 and a mortgage company 63 may partner with, be owned by, or otherwise form part of the business affiliation in order to provide loan, escrow, title clearance, closings and insurance services to members. In some jurisdictions, escrow and title clearance are performed by qualified attorneys 61, in others, the title company 66 or escrow companies 67 may perform these functions. In some jurisdictions, mortgage services may only be provided by state licensees.

For, large capital investment, financial partners 64 may enter into agreements with the management ownership corporation 50, storefront franchise corporation 17 and website corporation 11 to invest large capital amounts in real estate with particular investment criteria. Financial partners 64 will typically be institutional funds managers, who transfer capital into the system in exchange for equity held in properties.

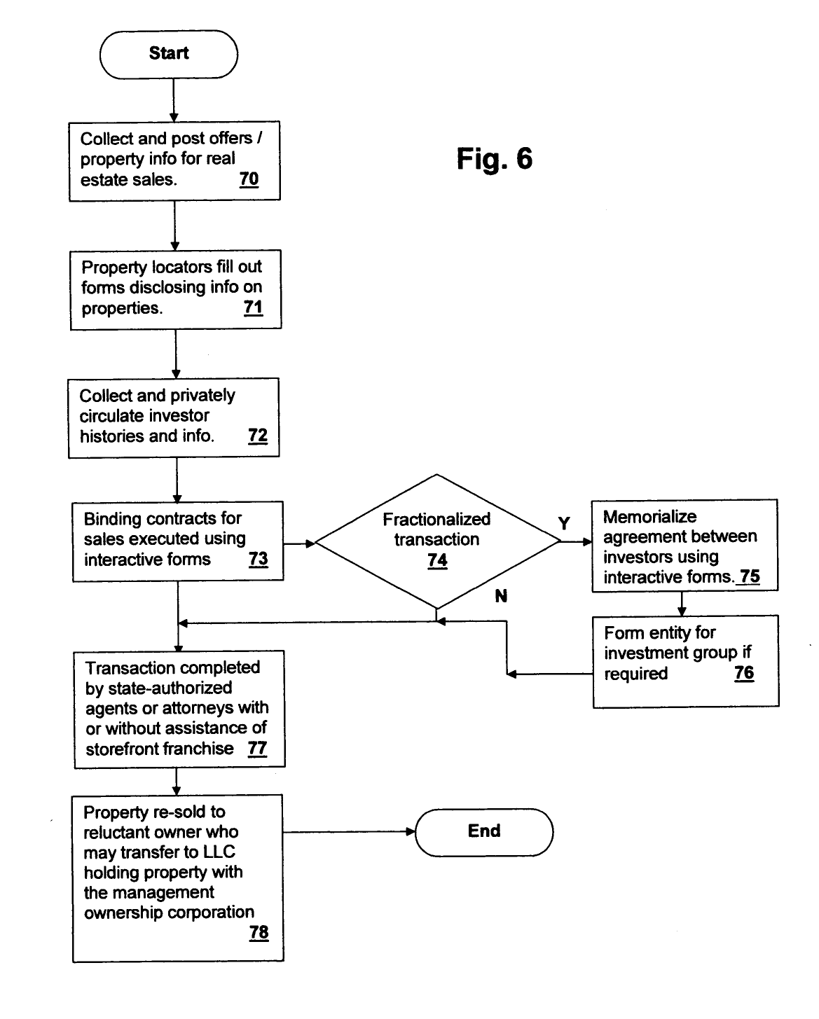

Referring now to FIG. 6, operation of a transactional business system in accordance with an embodiment of the present invention is depicted in a flowchart. Owners, agents, property locators, investors and franchisee users post properties for sale on the website in the tier or tiers to which they have access (step 70). On tier 3, forms are filled out by property locators that disclose all information to investors and franchisee users to permit them to qualify a property fitting their individual criteria, as well as the criteria taught by the business affiliation (step 71). Property locator, investor, and franchisee user histories are collected by the system and made available to is the investors, franchisee users and their mentors as permitted by the rules described above (step 72). Interactive forms for making offers and acceptance are used by the tier 3 and above members to negotiate binding contracts for the purchase of the properties or assignment of contracts on properties (step 73). Investors and franchisee users can initiate fractionalized investments (decision 74) and if other investors/franchisee users approve, they memorialize the agreement (step 75) using interactive forms of offer, assignment, ownership and management governance provided by the website and may include entities formed by the corporate services corporation or independent providers (step 76). The transaction may then be completed by attorneys approved by, escrow agencies or title companies which are affiliated business corporations or by independent entities, with or without assistance by franchisee real estate agents or brokers (step 77). After acquisition, the properties may be held or resold to reluctant owners who may hold them or transfer partial-ownership in them to an LLC or the management ownership corporation as explained above (step 78).

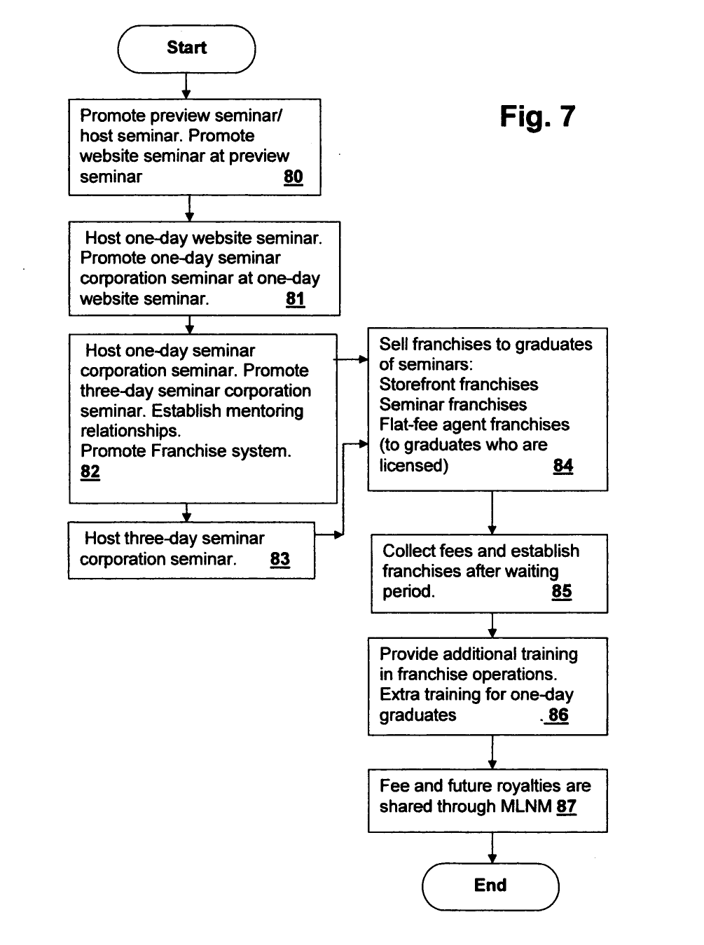

Referring now to FIG. 7, a seminar/franchise/website membership promotion and operation in accordance with an embodiment of the present invention is depicted. The preview seminar is promoted on the seminar corporation's website, the website corporation's website, through e-mail, and through the use of the infomercial on over-the-air television and cable television, and other means in order to draw attendees from the public (step 80). The one-day seminar explaining short-term real estate transactions using the website corporation's website is promoted at the preview seminar (step 81). At the one-day website corporation's seminar, use of the website's forms and methods of property acquisition and resale are taught and a package of discounted website services and training are promoted, along with the seminar corporation's paid one-day seminar (step 82). Attendees of the seminar corporation's one-day paid seminar are taught property location and qualification, negotiation with owners and property disposition, and the three-day seminar and the storefront franchise advantages are promoted. Mentor/mentored person relationships are created at the seminars. Graduates are encouraged to purchase storefront franchises through their education at the seminars as to the advantages in being a franchisee, through their relationships with franchisee teachers/mentors and by visiting actual storefront franchise offices during, after the seminars and by being shown virtual franchise storefronts on the website corporation's website (step 84).

If a seminar graduate express an interest in purchasing a storefront franchise after the one-day seminar, they can purchase a storefront franchise, but must also attend more extensive post-franchise-purchase training (step 86) than if they purchase a storefront franchise after attending the 3-day hands-on training (step 83). The storefront franchise collects its franchise fee after the statutory waiting period (step 85) and then pays then pays a franchise fee and a portion of the royalties it will collect to the MLMN corporation (unless the referring member is the seminar corporation), which then redistributes a portion of the franchise fee and royalties it receives through the MLNM affiliation in accordance with whom referred the storefront franchisee (step 87). If the seminar corporation referred the storefront franchisee, it receives a portion of the franchise fee and of the royalties the storefront franchise corporation will collect.

If a seminar graduate express an interest in purchasing a seminar franchise after the one-day seminar, they can purchase a seminar franchise if one is available for the geographic area they desire after the statutory waiting period, but must also attend more training than they would have to attend if they waited until after attending the 3-day hands-on training.

The above-described business method is unique to the business affiliation described herein and includes, but is not limited to: offering joint sales and training seminars, matching property locators with investors and franchisee users via the website and seminars, providing virtual and actual storefront franchises and/or seminar corporation franchises to graduates of the seminar programs, and mentoring of seminar graduates by successful seminar graduates, co-sponsors, seminar franchisees and franchisee users.

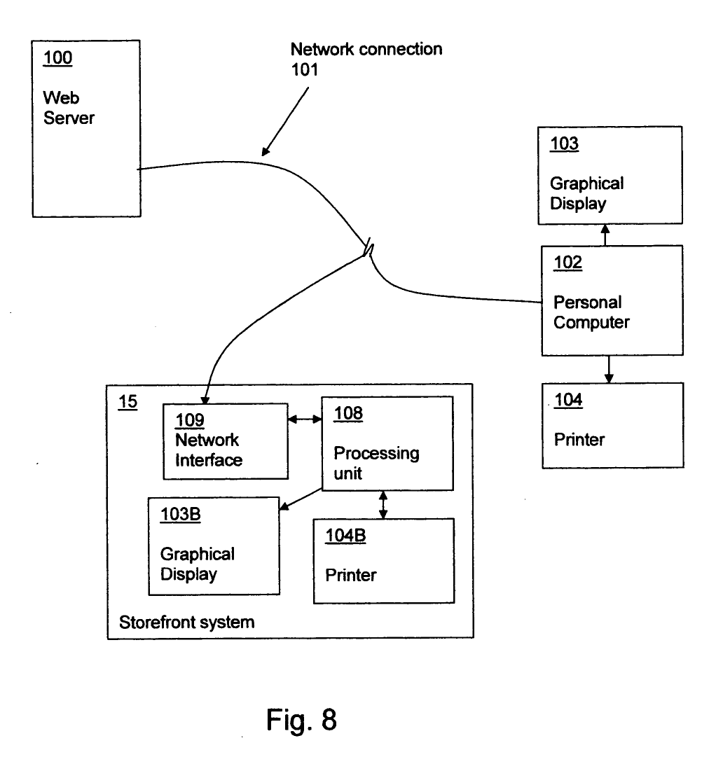

Referring now to FIG. 8, an exemplary computer system in which the methods of the present invention may be practiced is shown in a block diagram. A web server 100 provides content in the form of web pages that are accessed by a user of a personal computer 102 that includes a graphical display 103 for displaying web pages having features corresponding to the level of the user as described above with respect to the multi-level website 10. An Internet connection 101 provides the connection between personal computer 102 and the web server 100. Web server 100 is exemplary and in general will represent a large array of servers for providing the necessary Internet bandwidth to support the large-scale operations as described above. Web server 10 includes processors for executing program instructions in accordance with embodiments of the present invention and also a memory that holds the program instructions for execution by the processor. Web server 100 also includes storage devices for storing files encoding computer program products in accordance with embodiments of the present invention. Personal computer 102 generally executes a general-purpose web browser for accessing the content provided by server 100, but may also include dedicated programs for carrying out the methods used in the business described above. Personal computer 102 is coupled to a printer 104 for printing forms provided by server 100. A storefront system 105 may be connected via the Internet or via an intranet to web server 10 and is generally of the same form as personal computer 102 including a printer 104B for printing forms for use with storefront customers. Network interface 109 couples processing unit 108 to the Internet or intranet connection to server 100 and a graphical display 103B is provided for viewing content provided from server 100. Processing unit 188 contains a memory and processor for executing either a general-purpose browser interacting with content in accordance with the present invention as provide by server 100, and/or may include dedicated programs for enabling storefront operations.

While the invention has been particularly shown and described with reference to the preferred embodiments thereof, it will be understood by those skilled in the art that the foregoing and other changes in form, and details may be made therein without departing from the spirit and scope of the invention.

1. A method of operating a real estate business affiliation, comprising:
providing seminars for training persons in procedures for locating properties having at equity in excess of purchase price or positive cash flow and executing contracts for the purchase of said properties;
certifying graduates of said seminars as being trained in said procedures;
offering franchises to said certified graduates, whereby said certified graduates can provide services to the public related to said procedures; and
establishing franchises for said certified graduates who accept said offered franchises.

2. The method of claim 1, wherein said providing provides seminars for training said persons in the presentation of seminars for training of other persons, wherein said offering comprises offering seminar franchises to said certified graduates, and wherein said services comprise providing seminars for training said other persons.

3. The method of claim 1, wherein said providing provides seminars for training said persons in the operation of storefronts for providing assistance to the public associated with said procedures, wherein said offering comprises offering storefront franchises to said certified graduates, and wherein said services are providing said assistance.

4. The method of claim 1, further comprising establishing formalized mentoring relationships between said persons and certified graduates of said seminars, whereby effectiveness of said persons in using methods of said business affiliation is furthered.

5. The method of claim 1, wherein said persons are referred by a certified graduate of said seminars and further comprising rewarding said certified graduate and previous referrers of said certified graduate for said referral according to a multi-level network marketing structure.

6. The method of claim 1, further comprising providing a website for facilitating locating said properties and executing contracts for the purchase of said properties, wherein said website includes multiple levels of access, at least some of which are only accessible to said certified graduates.

7. The method of claim 1, wherein said multiple levels comprise at least one level only accessible by said franchisees of said established franchises, whereby said franchisees may communicate and access information available at other levels.

8. The method of claim 1, wherein said website further includes tools for execution of multi-owner agreements for the acquisition of real properties, whereby real property investment is facilitated by said website.

9. The method of claim 1, wherein said seminars further include seminars for training said persons in execution of multi-party agreements for the purchase of real properties, whereby real property investment may be facilitated by said certified graduates.

10. The method of claim 1, wherein said persons are licensed real estate professionals, and wherein said franchises are franchises for flat-fee real estate franchises, wherein said certified graduates who are licensed real estate professionals are franchisees who offer flat-fee real estate services.

11. The method of claim 1, further comprising providing a property management organization that purchases interests in property and holds them for investment or sale.

12. The method of claim 11, further comprising providing a services organization that establishes holding entities for partial interests in said property for previous owners of said properties, whereby said property management organization and said holding entities jointly own said property.

13. The method of claim 12, wherein said property management organization further receives side funds from said previous owners for paying down the principle of loans on said property, whereby capital interest in said property is accelerated.

14. The method of claim 1, further comprising providing a services organization that provides business services to said persons, wherein said persons are referred to said services organization by a certified graduate of said seminars and further comprising rewarding said certified graduate and previous referrers of said certified graduate for said referral to said services organization according to a multi-level network marketing structure.

15. The method of claim 1, further comprising providing a mortgage company that provides loans to said persons, wherein said persons are referred to said mortage organization by a certified graduate of said seminars and further comprising rewarding said certified graduate and previous referrers of said certified graduate for said referral to said mortgage company according to a multi-level network marketing structure.

16. A method of facilitating real estate transactions over the Internet, comprising:
providing a website having a first level interface for posting of properties and interests in properties for sale, said interests including contracts for the purchase of said properties;
providing a second level interface on said website accessible only to members of said website who have paid a membership fee; and
providing one or more higher levels of interface only to a certified graduate of a real estate training seminar for training persons in procedures for locating properties having at equity in excess of purchase price or positive cash flow and executing contracts for the purchase of said properties.

17. The method of claim 16, wherein said one or more higher levels of interface include a franchisee interface, wherein only a franchisee member of said website may access the franchisee interface, and wherein said franchisee interface provides access to all other levels of said website.

18. The method of claim 16, wherein said one or more higher levels of interface include an investment interface having tools for execution of multi-owner agreements for the acquisition of real properties, whereby real property investment is facilitated by said website.

19. The method of claim 18, wherein said one or more higher levels include a information interface whereby prospective parties to said multi-owner agreements may view histories of other prospective parties to said multi-owner agreements.

20. The method of claim 16, wherein said one or more higher levels include a diary interface whereby progress of said certified graduate in real estate business is recorded, and wherein said diary interface is accessible by a mentor of said certified graduate.

21. A computer system, comprising a server processor for executing program instructions and a memory for storing said program instructions, wherein said program instructions are program instructions for providing a website for facilitating a real estate business, said program instructions comprising program instructions for:
providing a website having a first level interface for posting of properties and interests in properties for sale, said interests including contracts for the purchase of said properties;
providing a second level interface on said website accessible only to members of said website who have paid a membership fee; and
providing one or more higher levels of interface only to a certified graduate of a real estate training seminar for training persons in procedures for locating properties having at equity in excess of purchase price or positive cash flow and executing contracts for the purchase of said properties.

22. The computer system of claim 21, wherein said one or more higher levels of interface include a franchisee interface, wherein only a franchisee member of said website may access the franchisee interface, and wherein said franchisee interface provides access to all other levels of said website.

23. The computer system of claim 21, wherein said one or more higher levels of interface include an investment interface having program instructions for providing tools for execution of multi-owner agreements for the acquisition of real properties, whereby real property investment is facilitated by said website.

24. The computer system of claim 21, wherein said one or more higher levels include a information interface whereby prospective parties to said multi-owner agreements may view histories of other prospective parties to said multi-owner agreements.

25. The computer system of claim 21, wherein said one or more higher levels include program instructions implementing a diary interface whereby progress of said certified graduate in real estate business is recorded, and wherein said diary interface is accessible by a mentor of said certified graduate.

26. A computer program product, comprising signal-bearing media encoding program instructions for executing on an Internet server, wherein said program instructions are for providing a website for facilitating a real estate business, said program instructions comprising:
providing a website having a first level interface for posting of properties and interests in properties for sale, said interests including contracts for the purchase of said properties;
providing a second level interface on said website accessible only to members of said website who have paid a membership fee; and
providing one or more higher levels of interface only to a certified graduate of a real estate training seminar for training persons in procedures for locating properties having at equity in excess of purchase price or positive cash flow and executing contracts for the purchase of said properties.

27. The computer program product of claim 26, wherein said one or more higher levels of interface include a franchisee interface, wherein only a franchisee member of said website may access the franchisee interface, and wherein said franchisee interface provides access to all other levels of said website.

28. The computer program product of claim 26, wherein said one or more higher levels of interface include an investment interface having program instructions for providing tools for execution of multi-owner agreements for the acquisition of real properties, whereby real property investment is facilitated by said website.

29. The computer program product of claim 26, wherein said one or more higher levels include a information interface whereby prospective parties to said multi-owner agreements may view histories of other prospective parties to said multi-owner agreements.

30. The computer program product of claim 26, wherein said one or more higher levels include program instructions implementing a diary interface whereby progress of said certified graduate in real estate business is recorded, and wherein said diary interface is accessible by a mentor of said certified graduate.
